(19) United States
(12) Patent Application Publication
(10) Pub. No.: US 2015/0241958 A1
(43) Pub. Date: Aug. 27, 2015

(54) ELECTRONIC DEVICE AND CONTROL METHOD THEREOF

(71) Applicant: Acer Incorporated, New Taipei City (TW)

(72) Inventors: Hao-Ting Chang, New Taipei City (TW); Bo-Fu Li, New Taipei City (TW)

(21) Appl. No.: 14/515,533

(22) Filed: Oct. 16, 2014

(30) Foreign Application Priority Data
Feb. 26, 2014 (TW) 103106511

(51) Int. Cl. G06F 3/01; G06F 3/0487; G06F 3/0484

(52) U.S. Cl. CPC G06F 3/011; G06F 3/0484; G06F 3/0487

(57) ABSTRACT

An electronic device and a control method thereof are provided. The method includes: controlling the electronic device by using first configuration information; determining whether at least one external object independent of the electronic device is existed in response to a trigger event; obtaining distance information of the external object when the external object is determined to be existed; determining whether the distance information is in conformed with a threshold condition; and switching to control the electronic device by using second configuration information when the distance information is determined to be conformed with the threshold condition.

### CROSS-REFERENCE TO RELATED APPLICATION

This application claims the priority benefit of Taiwan application serial no. 103106511, filed on Feb. 26, 2014. The entirety of the above-mentioned patent application is hereby incorporated by reference herein and made a part of this specification.

### BACKGROUND OF THE INVENTION

1. Field of the Invention

The invention relates to an electronic device, and more particularly, to an electronic device and a control method thereof.

2. Description of Related Art

In general, in order for electronic devices to conform with use habits of various types of users, the electronic devices usually provide settings or adjustment functions of some parameters, so that the users may adjust brightness of screens, volume of the speakers or so forth based on self needs. However, adjustments of these parameters are commonly established to be manually performed by the users, rather than automatically performed by the electronic devices based on current states of the users. Whereas, a small portion of functions that can be automatically adjusted by the electronic devices, such as the screen of a smart phone would automatically be closed if the face of a user is becoming close to the screen during a phone call or the brightness of the screen being automatically adjusted based on environment brightness, is only for preventing certain functions from being executed unexpectedly as the user face inadvertently touches the screen during the phone call, or only for adjusting the electronic device based on the changes of external environment. Namely, the user is unable to truly enable the electronic device to automatically adjust to an operational state best meeting the current needs of the user.

### SUMMARY OF THE INVENTION

The invention is directed to an electronic device and a control method thereof, which may enable the electronic device to automatically adjust to an operational state best meeting the current needs of the user without requiring any input of command or voice.

The invention is directed to a control method of an electronic device, and this method includes: controlling the electronic device by using first configuration information; determining whether at least one external object independent of the electronic device is existed in response to a trigger event; obtaining distance information of the external object when the external object is determined to be existed; determining whether the distance information is conformed with a threshold condition; and switching to control the electronic device by using second configuration information when the distance information is determined to be conformed with the threshold condition.

In view of another perspective, the invention is directed to an electronic device. This electronic device includes a sensor, a storage circuit and a processing circuit. The storage circuit is configured to store first configuration information and second configuration information. The processing circuit is coupled to the sensor and the storage circuit. The processing circuit is configured to execute the following operations: controlling the electronic device by using the first configuration information; determining whether at least one external object independent of the electronic device is existed in response to a trigger event through using the sensor; obtaining distance information of the at least one external object through using the sensor when the at least one external object is determined to be existed; determining whether the distance information is conformed with a threshold condition; and switching to control the electronic device by using the second configuration information when the distance information is determined to be conformed with the threshold condition.

In view of the above, after receiving a trigger event, the invention determines whether an external object independent of the electronic device is existed. If the external object independent of the electronic device is existed, then a proper configuration information is selected for controlling the electronic device according to the distance information of the external object. As such, the user may enable the electronic device to automatically adjust to the operational state best meeting the current needs of the user without requiring to input any command.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are schematic diagrams illustrating an electronic device according to an exemplary embodiment of the invention.

FIG. 2 and FIG. 3 are schematic diagrams illustrating a change in distance between an external object and the electronic device according to an exemplary embodiment of the invention.

FIG. 4 is schematic diagram illustrating objects being shown on a user interface via a first mode according to an exemplary embodiment of the invention.

FIG. 5 is schematic diagram illustrating objects being shown on a user interface via a second mode according to an exemplary embodiment of the invention.

FIG. 6 is schematic diagram illustrating objects being shown on a user interface via a first mode according to another exemplary embodiment of the invention.

FIG. 7 is schematic diagram illustrating objects being shown on a user interface via a second mode according to another exemplary embodiment of the invention.

FIG. 8 is schematic diagram illustrating a target object being shown on the user interface via the first mode according to another exemplary embodiment of the invention.

FIG. 9 is a flow chart illustrating a control method of an electronic device according to an exemplary embodiment of the invention.

### DESCRIPTION OF THE EMBODIMENTS

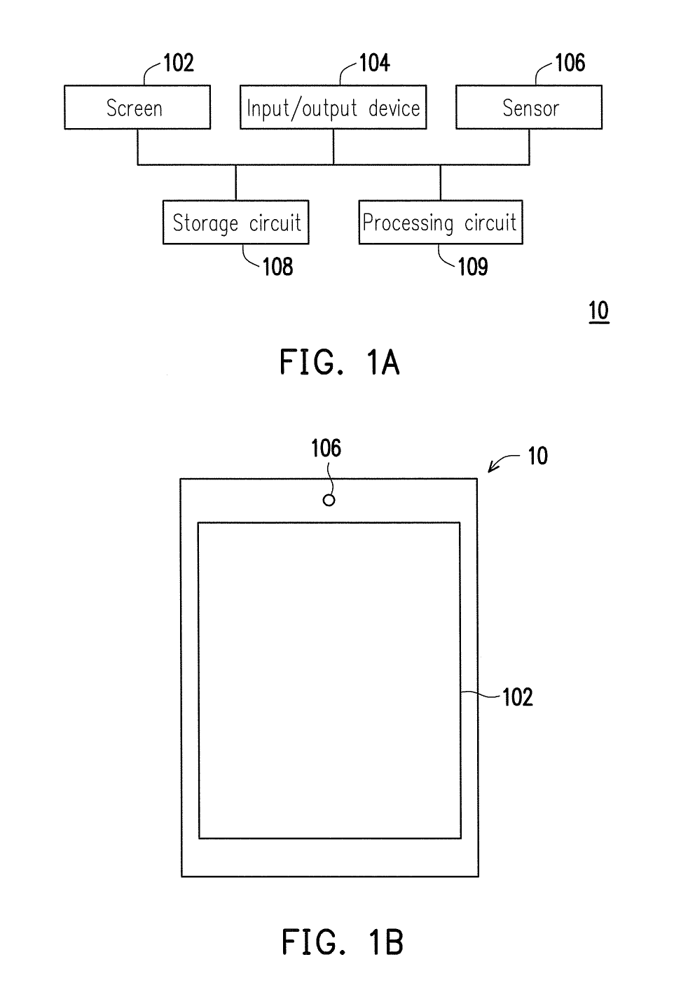

FIG. 1A and FIG. 1B are schematic diagrams illustrating an electronic device according to an exemplary embodiment of the invention.

Referring to FIG. 1A and FIG. 1B, in the present exemplary embodiment, the electronic device 10 may be a smart phone, a tablet PC, an e-book or a game console, but not limited thereto. In another exemplary embodiment, the electronic device 10 may also be a variety of electronic devices having display and operating functions, such as a notebook, a desktop computer, a smart TV and so forth.

In the exemplary embodiment, the electronic device 10 includes a screen 102, an input/output device 104, a sensor 106, a storage circuit 108 and a processing circuit 109.

The screen 102 may be an electrophoretic display, a LCD monitor, a plasma display, an organic light-emitting diodes display, and not limited thereto. In another exemplary embodiment, the screen 102 may further be various types of touch screen, such as a resistive touch screen, a capacitive touch screen, an optical touch screen, an acoustic wave touch screen or an electromagnetic touch screen, but not limited thereto.

The input/output device 104 may further includes a mouse, a keyboard, a touch pad, a speaker, a microphone, and a vibrator, but not limited thereto.

The sensor 106 may include at least one of a proximity sensor, a photographic lens, an optical sensor and a wireless communication circuit or a combination thereof, but is not limited thereto.

The storage circuit 108 may include a storage media such as memory or Hard Disk Drive (HDD), but is not limited thereto. The storage circuit 108 is stored with a plurality of configuration information. Each of the configuration information includes the information of configuration parameters corresponding to one or more components of the electronic device 10. For instance, each of the configuration information may include the information of at least one of a display parameter, a volume/vibration parameter and a configuration parameter of a user interface, but not limited thereto. For instance, the information of the display parameter may be information for indicating the brightness, the saturation and the resolution of the screen 102. For instance; the volume/vibration parameter may be information for indicating a play volume of a ringtone alert from the speaker and/or a vibration intensity of a vibrating alert of the vibrator of the electronic device 10 when there is an incoming call or a message being received. In addition, the configuration parameter of the user interface may be information for indicating the presentation of the user interface displayed on the screen 102.

The processing circuit 10 may be a central processing unit (CPU), a micro-processor or an embedded controller, and is not limited thereto. The processing circuit 109 is configured to control the overall operation of the electronic device 10.

In the exemplary embodiment, the processing circuit 109 firstly controls the electronic device 10 by using one of the configuration information (hereinafter referred to as “first configuration information”) in the storage circuit 108. For instance, the processing circuit 109 may control the screen 102, the speaker and/or the vibrator of the electronic device 10 according to the first configuration information.

Then, the processing circuit 109 waits for a trigger event. This trigger event may be generated by the processing circuit 109 or transmitted from the other components of the electronic device 10 to the processing circuit 109. In an exemplary embodiment, when the electronic device 10 finishes booting, the processing circuit 109 then generates or receives the trigger event, such that the processing circuit 109 may self-generate the trigger event, or receive the trigger event from a basic input/output system (BIOS).

However, in the present exemplary embodiment, the processing circuit 109 generates the trigger event when the electronic device 10 is idled for more than a preset time, and the preset time may, for example, be any second between 1 to 5 seconds, but not limited thereto. For instance, the processing circuit 109 may determine, within a preset time range after an operation command is received by the electronic device 10 in the last time, whether the electronic device 10 receives another operation command through the input/output device 104, such that this preset time range may be any second between 1 to 5 seconds, but not limited thereto. In addition, the operation command, for example, is inputted into the electronic device 10 by a user through touching the screen 102 or directly operating the input/output device 104, but the invention is not limited thereto. If the processing circuit 109 determines that the electronic device 10 does not receive any operation command through the screen 102 or the input/output device 104 within the preset time range, then the processing circuit 109 generates the trigger event.

Moreover, in another exemplary embodiment, the processing circuit 109 generates the trigger event only when the screen 102 displays a specific image for an amount of time exceeding the preset time. This specific image may, for example, be an operational image of a specific type of application. This specific type of application may, for example, include an application capable of showing at least one object on the screen 102, such as a desktop application, an instant messaging application, a SMS application, a web browser application, a calling application, a phonebook application, an e-mail application, and/or a file system application, but not limited thereto. In addition, the preset time may be any second between 1 to 5 seconds, but not limited thereto.

When the trigger event is detected, the processing circuit 109 determines whether at least one object (hereinafter referred to as “external object”) independent of the electronic device 10 is existed in response to the trigger event through using the sensor 106. In the present exemplary embodiment, the sensor 106 only detects the object within a preset range in front of the screen 102. For instance, as shown in FIG. 1B, the processing circuit 109 may detect the object in front of the screen 102 through using a proximity sensor, an optical sensor or a photographic lens in the sensor 106, and obtain a distance between the object and the electronic device 10 through using technique such as data analysis, light intensity analysis or image analysis. In addition, if the external object has a wireless communication circuit, then the processing circuit 109 may also perform a communication positioning to the object in front of the screen 102 through using a wireless communication protocol, such as Bluetooth (BT), supported by a wireless communication circuit of the electronic device 10. Then, the processing circuit 109 may determine whether at least one object (hereinafter referred to as “object to be detected”) is existed in front of the screen 102 by less than a preset distance apart through using the sensor 106. This preset distance may, for example, be from 5 cm to 50 cm, but not limited thereto. When it is determined that at least one object to be detected is existed in front of the screen 102 by the preset distance apart, the processing circuit 109 may determine at least one external object independent of the electronic device 102 is existed, and then set the at least one object to be detected as the at least one external object.

However, in another exemplary embodiment, the sensor 106 may also detect object at other directions (e.g., at the sides or the back of the electronic device 10) based on the configuration location of the sensor 106 or through using the wireless communication circuit of the electronic device 10, and set an object less than the preset distance apart from the electronic device 10 as the at least one external object, but the invention is not limited thereto.

When determines that the at least one external object is existed, the processing circuit 109 continues to obtain the distance information of the at least one external object through using the sensor 106. For instance, when the amount of the at least one external object is one, such as the head or the hand of the user operating the electronic device 10, then the distance information of the external object may include one of information of a distance between the external object and the electronic device 10, information of a distance change between the external object and the electronic device 10, information of an acceleration of the external object in relative to the electronic device 10 and information of an acceleration change of the external object in relative to the electronic device 10, but not limited thereto.

Moreover, when the amount of the at least one external object is greater than one (e.g., two or more than two heads and/or hands), the said distance between the external objects and the electronic device 10 may be an average value of the distance between each of the external objects and the electronic device 10, the said distance change between the external object and the electronic device 10 may be an average value of the distance change between each of the external objects and the electronic device 10, the said acceleration of the external objects in relative to the electronic device 10 may be an average value of the acceleration of each of the external objects in relative to the electronic device 10, and the said acceleration change of the external objects in relative to the electronic device 10 may be an average value of the acceleration change of each of the external objects in relative to the electronic device 10. In addition, the average value mentioned herein may also be a weighted average value or other values obtained based on the concept of averaging, but the invention e is not limited thereto.

Then, the processing circuit 109 determines whether the distance information is conformed with a threshold condition. For instance, in the present exemplary embodiment, the processing circuit 109 determines whether the distance between the at least one external object and the electronic device 10 is conformed with a distance threshold condition. Taking one external object being existed as an example, the processing circuit 109 may determine whether the distance between this external object and the electronic device 10 crosses over the distance threshold (e.g., the distance changes from less than the distance threshold to larger than the distance threshold, or changes from larger than the distance threshold to less than the distance threshold). If the distance between this external object and the electronic device 10 crosses over the distance threshold, then the processing circuit 109 determines that the distance between the at least one external object and the electronic device 10 is conformed with the distance threshold condition. In addition, if there is a plurality of external object being existed, then the processing circuit 109 may, for example, use the average value of the said distance to compare with the distance threshold, and thus no further elaboration is to be provided herein.

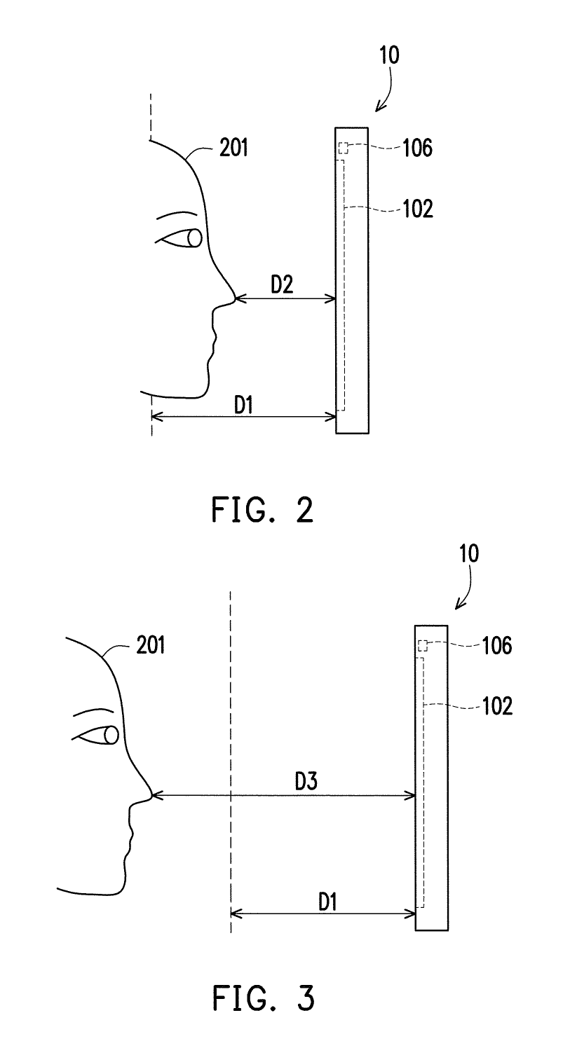

FIG. 2 and FIG. 3 are schematic diagrams illustrating a change in distance between an external object and the electronic device an exemplary embodiment of the invention.

Referring to FIG. 2, the distance threshold is assumed to be D1 cm, and a distance between the external object 201 (e.g., the head of the user) in front of the screen 102 and the electronic device 10 that is obtained by the processing circuit 109 through using the sensor 106 is D2, and D2 is less than D1. Then, referring to FIG. 3, after the head of the user moves backward (viz., a direction away from the electronic device 10), the distance between the external object 201 and the electronic device 10 is changed to D3, and D3 is greater than D1. Namely, as the user moves the head, the distance between the external object 201 and the electronic device 10 crosses over the distance threshold D1 (viz., changed from D2 to D3). When the processing circuit 109 knows that the distance between the external object 201 and the electronic device 10 crosses over the distance threshold D1, the processing circuit 109 determines that the distance between the external object 201 and the electronic device 10, at the current moment, is conformed with the distance threshold condition.

Afterward, if the user moves the head forward (viz. a direction towards the electronic device 10) again, thereby causing the distance between the external object 201 and the electronic device 10 to change from D3 back to D2 or a value less than the distance threshold D1, then when the processing circuit 109 knows that the distance between the external object 201 and the electronic device 10 again crosses over the distance threshold D1, the processing circuit 109 determines that the distance between the external object 201 and the electronic device 10, at the current moment, is conformed with the distance threshold condition.

In another exemplary embodiment, the processing circuit 109 determines whether the distance change between the external object 201 and the electronic device 10 is conformed with a distance change threshold condition. For instance, the processing circuit 109 may determine whether the distance change (or an average distance change) between the at least one external object and the electronic device 10 exceeds the distance change threshold. Taking FIG. 2 and FIG. 3 for instance, if the distance change (viz. changes from D2 to D3 or from D3 to D2) between the external object 201 and the electronic device 10 exceeds the distance change threshold, then the processing circuit 109 determines that the distance change between the external object 201 and the electronic device 10 is conformed with the distance change threshold condition. Moreover, in another exemplary embodiment, the processing circuit 109 determines whether the distance change between the external object 201 and the electronic device 10 falls within a distance change range. If the distance change between the external object 201 and the electronic device 10 falls within the distance change range, then the processing circuit 109 also determines that the distance change between the external object 201 and the electronic device 10 is conformed with the distance change threshold condition.

In another exemplary embodiment, the processing circuit 109 determines whether the acceleration of the at least one external object in relative to the electronic device 10 is conformed with an acceleration threshold condition. Taking FIG. 2 and FIG. 3 for instance, when the distance between the external object 201 and the electronic device 10 changes from D2 to D3 or from D3 to D2, if the acceleration exceed an acceleration threshold, such as when the acceleration of the external object 201 in relative to the electronic device 10 changes from less than the acceleration threshold to exceed the acceleration threshold, then the processing circuit 109 determines that the acceleration of the external object 201 in relative to the electronic device 10 is conformed with the acceleration threshold condition. Moreover, in another exemplary embodiment, the processing circuit 109 determines whether the acceleration of the external object 201 in relative to the electronic device 10 falls within an acceleration range. If the acceleration of the external object 201 in relative to the electronic device 10 falls within the acceleration range, then the processing circuit 109 also determines that the acceleration of the external object 201 in relative to the electronic device 10 is conformed with the acceleration threshold condition.

In another exemplary embodiment, the processing circuit 109 determines whether the acceleration change of the at least one external object in relative to the electronic device 10 is conformed with an acceleration change threshold condition. Taking FIG. 2 and FIG. 3 for instance, when the distance between the external object 201 and the electronic device 10 changes from D2 to D3 or from D3 to D2, if the acceleration change exceeds an acceleration change threshold, such as when the acceleration change of the external object 201 in relative to the electronic device 10 changes from less than the acceleration change threshold to exceed the acceleration change threshold, then the processing circuit 109 determines that the acceleration change of the external object 201 in relative to the electronic device 10 is conformed with the acceleration change threshold condition.

If the processing circuit 109 determines that the distance between the at least one external object and the electronic device 10 is conformed with the distance threshold condition, determines that the distance changed between the at least one external object and the electronic device 10 is conformed with the distance change threshold condition, determines that the acceleration of the at least one external object in relative to the electronic device 10 is conformed with the acceleration threshold condition or determines that the acceleration change of the at least one external object in relative to the electronic device 10 is conformed with the acceleration change threshold condition, then the processing circuit 109 may determine that the distance information of the at least one external object is conformed with the threshold condition. In addition, the distance threshold condition, the distance change threshold condition, the acceleration threshold condition and the acceleration change threshold condition may be used individually or in combination; the invention is not limited thereto. For instance, in an exemplary embodiment, the threshold condition may be set to include the distance change threshold condition and the acceleration threshold condition for a two-factor authentication, thereby reducing the risk of a false determination. In addition, the distance, the distance change, the acceleration and the acceleration change may also be the changes that are generated when the external object moves in relative to other directions of the electronic device 10, but the invention is not limited thereto.

When the distance information of the at least one external object is determined to be conformed with the threshold condition, the processing circuit 109 switches to control the electronic device 10 by using another configuration information (hereinafter referred to as “second configuration information”) in the storage circuit 108. A difference between the second configuration information and the first configuration information lies in at least part of the parameters being used differently. For instance, when the processing circuit 109 controls the electronic device 10 by using the first configuration information, the screen 102, the speaker and/or the vibrator of the electronic device 10 is operated under a condition corresponded to the first configuration information. When the processing circuit 109 switches to control the electronic device 10 by using the second configuration information, the screen 102, the speaker and/or the vibrator of the electronic device 10 is operated under a condition corresponded to the second configuration information. For instance, when the processing circuit 109 switches to control the electronic device 10 by using the second configuration information, the brightness of the screen 102 may be adjusted to higher or lower, the volume of the speaker may be adjusted to loud or quiet, and so forth, but not limited thereto.

Noteworthily, the amounts of the distance threshold, the distance change threshold, the acceleration threshold and the acceleration change threshold may respectively be one or a plurality. Taking the distance threshold for instance, when there is a plurality of distance thresholds existed, each of the distance thresholds may be corresponded to one configuration information, such that if a distance between an external object and the electronic device 10 crosses over a distance threshold, then the processing circuit 109 determines that the distance between the external object and the electronic device 10, at the current moment, is conformed with a distance threshold condition corresponding to the distance threshold, and may choose which of the configuration information in the storage circuit 108 is to be switched to based on the distance threshold condition.

Moreover, in an exemplary embodiment, the amounts of the distance change range and the acceleration range may also respectively be one or a plurality. Taking the acceleration range for instance, when there is a plurality of acceleration ranges existed, each of the acceleration ranges may be corresponded to one configuration information. Taking FIG. 2 and FIG. 3 for instance, when the distance between the external object 201 and the electronic device 10 changes from D2 to D3 or from D3 to D2, the processing circuit 109 may determine whether the acceleration of the external object 201 in relative to the electronic device 10 falls within one of the acceleration ranges. For instance, when the acceleration of the external object 201 in relative to the electronic device 10 falls within an acceleration range (hereinafter referred to as “first acceleration range”), the processing circuit 109 determines that the acceleration of the external object 201 in relative to the electronic device 10 is conformed with an acceleration threshold condition (hereinafter referred to as “first acceleration threshold condition”) corresponding to the first acceleration range. The first acceleration range may, for example, be within +33 cm/sec to +40 cm/sec (such that the external object 201 moves toward the electronic device 10). Then, based on the current conformed acceleration threshold condition being the first acceleration threshold condition, the processing circuit 109 may choose to switch to use the configuration information in the storage circuit 108 that is corresponded to the first acceleration threshold condition.

When the acceleration of the external object 201 in relative to the electronic device 10 falls within an acceleration range (hereinafter referred to as “second acceleration range”), the processing circuit 109 determines that the acceleration of the external object 201 in relative to the electronic device 10 is conformed to another acceleration threshold condition (hereinafter referred to as “second acceleration threshold condition”) corresponding to the second acceleration range. The second acceleration range may, for example, be within −33 cm/sec to −40 cm/sec (such that the external object 201 moves away from the electronic device 10). Then, based on the current conformed acceleration threshold condition being the second acceleration threshold condition, the processing circuit 109 may choose to switch to use the configuration information in the storage circuit 108 that is corresponded to the second acceleration threshold condition.

In an exemplary embodiment, the processing circuit 109 shows a user interface on the screen 102. When the processing circuit 109 controls the electronic device 10 by using the first configuration information, the processing circuit 109 shows at least one object in the user interface via a mode (hereinafter referred to as “first mode”). The at least one object may, for example, be an object that is shown as corresponding to a variety of applications, such as web pages, contacts, friends, instant messages, SMS, e-mails, application shortcuts, desktop/desktop themes, files or folders, but not limited thereto. When the processing circuit 109 switches from using the first configuration information to the second configuration information to control the electronic device 10, the processing circuit 109 switches to show the at least one object in the user interface via another mode (hereinafter referred to as “second mode”). For instance, when the processing circuit 109 switches to show the at least one object in the user interface via the second mode, the processing circuit 109 may execute at least one of the following operations, such as to switch the arrangement of the at least one object shown in the user interface, switch the amount of the at least one object shown in the user interface, switch from displaying some of the information (or referred to as the first information) of the at least one object to displaying some of the another information (or referred to as the second information) of the at least one object, and switch from displaying one object (or referred to as the first object) in the at least one object to displaying another object (or referred to as the second object) in the at least one object. Taking the web browser application for instance, if the at least one object is a web page shown by the web browser application, then when the processing circuit 109 switches to shown the at least one object on the user interface via the second mode, the processing circuit 109 may, for example, executes an operation to switch the web page to previous page, next page or home page.

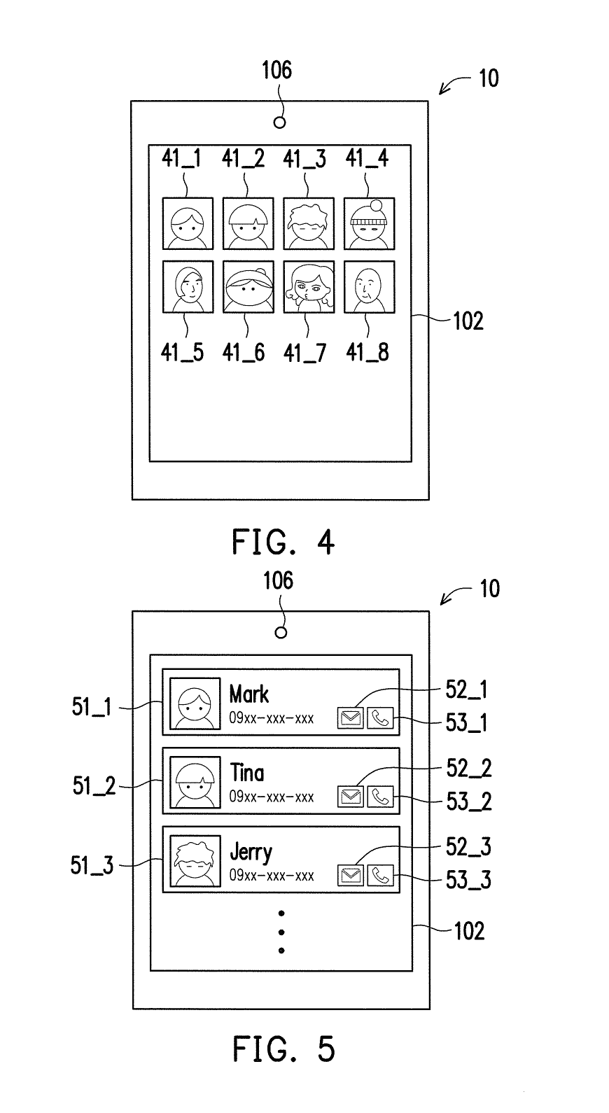

FIG. 4 is schematic diagram illustrating objects being shown on a user interface via a first mode according to an exemplary embodiment of the invention, and FIG. 5 is schematic diagram illustrating objects being shown on the user interface via a second mode according to an exemplary embodiment of the invention.

Referring to FIG. 4, taking an operational image of the instant messaging application for instance, when the processing circuit 109 controls the electronic device 10 by using the first configuration information, the screen 102 displays objects 41_1 to 41_8. Each of the objects 41_1 to 41_8 includes displaying an image of a contact.

Referring to FIG. 5, when the processing circuit 109 switches to control the electronic device 10 by using the second configuration information, the screen 102, for example, displays objects 51_1 to 51_3, and the objects 51_1 to 51_3 are respectively corresponded to the contact of each of the objects 41_1 to 41_3. Each of the objects 51_1 to 51_3 may include displaying detail information related to a contact, such as an image, a name and a phone number of the Contact. It can be known from FIG. 4 and FIG. 5, when the configuration information used for controlling the electronic device 10 is being switched, the size, the amount, the information content and the arrangement of the object displayed in the user interface may also be changed.

In an exemplary embodiment, when the processing circuit 109 switches to control the electronic device 10 by using the second configuration information, the processing circuit 109 further shows at least one functional option in the user interface, and each functional option is related to one of the at least one object. The processing circuit 109 may receive an operation corresponding to one the at least one functional option through the input/output device 104 or screen 102, and execute an application function corresponding to one the at least one object according to this operation.

Referring to FIG. 4 and FIG. 5 again, when the processing circuit 109 switches to control the electronic device 10 by using the second configuration information, the processing circuit 109 may show additional functional options 52_1 to 52_3 and 53_1 to 53_3 in the user interface. The functional options 52_1 and 53_1 are related to the object 51_1, the functional options 52_2 and 53_2 are related to the object 51_2, and the functional options 52_3 and 53_3 are related to the object 51_3. Moreover, the functional options 52_1 to 52_3 are, for example, configured to trigger the SMS application, and the functional options 53_1 to 53_3 are, for example, configured to trigger the calling application. Assuming that the operation of the user is to choose the functional option 52_1, and then the processing circuit 109 may execute a SMS application function corresponded to a contact “Mark” based on this operation. The SMS application function corresponded to the contact “Mark” is, for example, to display a SMS editing image for a receiver “Mark” that is already been set. Assuming that the operation of the user is to choose the functional option 53_3, and then the processing circuit 109 may execute a calling application function corresponded to a contact “Jerry” based on this operation. The calling application function corresponded to the contact “Jerry” is, for example, to call the contact “Jerry”.

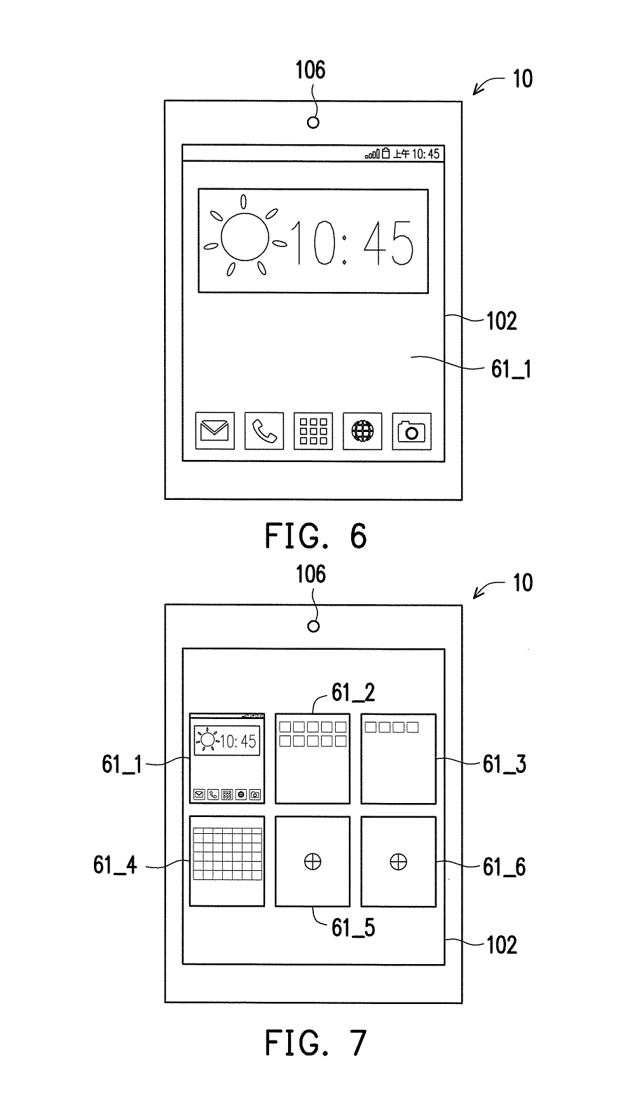

FIG. 6 is schematic diagram illustrating objects being shown on the user interface via a first mode according to another exemplary embodiment of the invention, and FIG. 7 is schematic diagram illustrating objects being shown on the user interface via a second mode according to another exemplary embodiment of the invention.

Referring to FIG. 6, taking an operational image of the Desktop application for instance, when the processing circuit 109 controls the electronic device 10 by using the first configuration information, the screen 102 displays an object 61_1. The object 61_1, for example, is one of a plurality of desktops or desktop themes of the electronic device 10. Referring to FIG. 7, when the processing circuit 109 controls the electronic device 10 by using the second configuration information, the screen 102 displays objects 61_1 to 61_6. The objects 61_1 to 61_6, for example, are all desktops or desktop themes of the electronic device 10. Then, the user may browse and/or edit all the desktops or desktop themes of the electronic device 10. Moreover, in another exemplary embodiment, when the processing circuit 109 controls the electronic device 10 by using the second configuration information, the screen 102 changes from displaying the object 61_1 to displaying the object 61_2, any one of the objects 61_2 to 61_6 or any amount of the objects 61_1 to 61_6, but the invention is not limited thereto.

Moreover, in an exemplary embodiment, when the processing circuit 109 switches to control the electronic device 10 by using the second configuration information, the processing circuit 109 only show a portion of the objection in the user interface via the second mode, and continues to the other portion of the object via the first mode. For instance, when the processing circuit 109 switches to control the electronic device 10 by using the second configuration information, the processing circuit 109 may obtain at least one object (hereinafter referred to as “target object”), which conforms with a target condition, in the at least one object, and then shows the at least one target object in the user interface via the second mode.

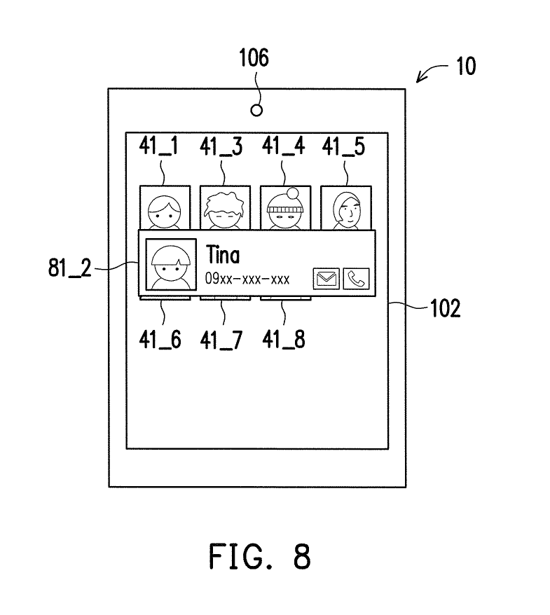

FIG. 8 is schematic diagram illustrating a target object being shown on the user interface via the first mode according to an exemplary embodiment of the invention.

Referring to FIG. 4 and FIG. 8, when the processing circuit 109 switches to control the electronic device 10 by using the second configuration information, the processing circuit 109 may identify at least one target object in the objects 41_1 to 41_8 that conforms with a target condition. Assuming that only the object 41_2 in the objects 41_1 to 41_8 is conformed with the target condition, then the processing circuit 109 may switch to replace the original object 41_2 with an object 81_2 shown by the second mode, and continues to show the objects 41_1 and 41_3 to 41_8 via the first mode. As such, when the processing circuit 109 switches to control the electronic device 10 by using the second configuration information, the processing circuit 109 may assist the user to quickly find the favorite or more concerned object 81_2 from the objects 41_1 to 41_8, thereby reducing the time required for searching the object one by one. In addition, the object 81_2, for example, is similar or different from the object 51_2 in FIG. 5, but the invention is not limited thereto.

In the present exemplary embodiment, the processing circuit 109, for example, select the target object from the at least one object by means of checking the label of each object and/or the name of an object of comparison. For instance, the target object conforming with the target condition may be objects corresponded to the commonly used contacts and/or favorite contacts in the contract lists of a various types of application of the electronic device 10, such as the phonebook application, the e-mail application and/or the instant messaging application, and/or objects corresponded to relatively important friends on a friend list of a social network website and/or an online service provider website (e.g., email service provider website such as gmail and/or video service providers website such as youtube), such as Facebook or Twitter, but not limited thereto. Moreover, in another exemplary embodiment, the target object conforming with the target condition may also be web pages, instant messages, SMS, emails, application shortcuts, desktops/desktop themes, files or folders preset by the user in arbitrary, or self-determined by the processing circuit 109 as being relatively important to the user, but the invention is not limited thereto.

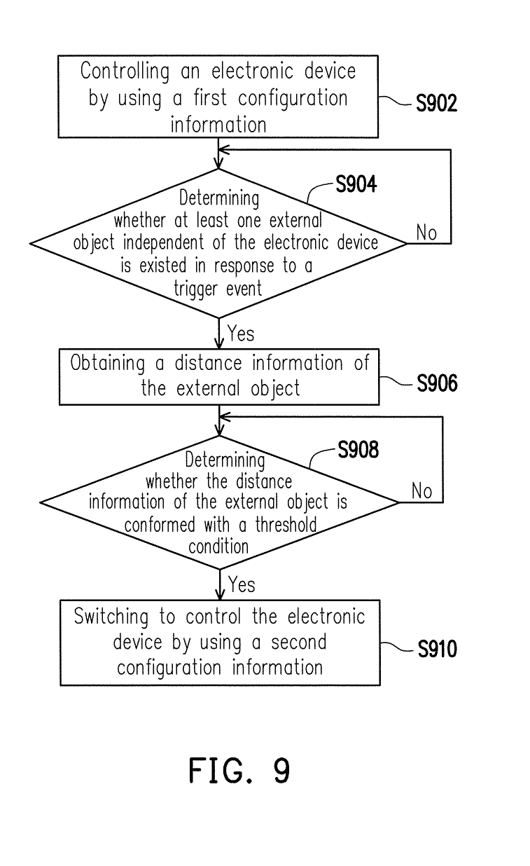

FIG. 9 is a flow chart illustrating a control method of an electronic device according to an exemplary embodiment of the invention.

Referring to FIG. 9, in step S902, the electronic device 10 is being controlled by the processing circuit 109 using first configuration information.

In step S904, whether there exists at least one external object independent of the electronic device 10 is being determined by the processing circuit 109 in response to a trigger event.

When determines that the external object is existed, in step S906, distance information of the external object is being obtained by the processing circuit 109. Contrarily, if the external object is not existed, then after step S906, step S904 is being re-executed by the processing circuit 109.

In step S908, whether the distance information of the external object is conformed with a threshold condition is being determined by the processing circuit 109.

When determines that the distance information of the external object is conformed with the threshold condition, in step S910, the electronic device 10 is being switched to be controlled by the processing circuit 109 using second configuration information. Contrarily, if the distance information of the external object is not conformed with threshold condition, then after step S908, step S908 is being re-executed by the processing circuit 109.

Details regarding each step in FIG. 9 are described as above, and thus no further elaboration is to be provided herein. Noteworthily, each step in FIG. 9 may substantially be used as a plurality of programming codes or circuits, and the invention is not limited thereto. In addition, the method described in FIG. 9 may be used in coordination with the above embodiments or be used independently, and the invention is not limited thereto.

In summary, in the invention, the electronic device and the control method thereof, after receiving a trigger event, may determine whether an external object independent of the electronic device is existed. If the external object independent of the electronic device is existed, then a proper configuration information is selected for controlling the electronic device according to distance information of the external object. As such, the user may enable the electronic device to automatically adjust to the operational state best meeting the current needs of the user without requiring to input any command.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control method of an electronic device comprising:
controlling the electronic device by using first configuration information;
determining whether at least one external object independent of the electronic device is existed in response to a trigger event;
obtaining distance information of the at least one external object when the at least one external object is determined to be existed;
determining whether the distance information is conformed with a threshold condition; and
switching to control the electronic device by using second configuration information when the distance information is determined to be conformed with the threshold condition.

2. The control method of an electronic device as recited in claim 1, wherein after the step of controlling the electronic device by using the first configuration information, the method further comprises:
determining whether an operation command is received by the electronic device within a preset time range; and
generating the trigger event if the electronic device does not receive the operation command within the preset time range.

3. The control method of an electronic device as recited in claim 1, wherein the step of determining whether the at least one external object independent of the electronic device is existed comprises:
determining whether at least one object to be detected is existed in front of a screen of the electronic device by less than a preset distance apart; and
determining that the at least one external object independent of the electronic device is existed when the at least one object to be detected is existed in front of the screen by less than the preset distance apart, and setting the at least one object to be detected as the at least one external object.

4. The control method of an electronic device as recited in claim 1, wherein the distance information of the at least one external object comprises at least one of information of a distance between the at least one external object and the electronic device, information of an distance change between the at least one external object and the electronic device, information of an acceleration of the at least one external object in relative to the electronic device, and information of an acceleration change of the at least one external object in relative to the electronic device.

5. The control method of an electronic device as recited in claim 4, wherein when an amount of the at least one external object is greater than one, the distance between the at least one external object and the electronic device comprises an average value of the distance between each of the external objects and the electronic device, the distance change between the at least one external object and the electronic device comprises an average value of the distance change between each of the external objects and the electronic device, the acceleration of the at least one external object in relative to the electronic device comprises an average value of the acceleration of each of the external objects in relative to the electronic device, and the acceleration change of the at least one external object in relative to the electronic device comprises an average value of the acceleration change of each of the external objects in relative to the electronic device.

6. The control method of an electronic device as recited in claim 1, wherein the step of determining whether the distance information is conformed with the threshold condition comprises at least one of the following steps:
determining whether a distance between the at least one external object and the electronic device is conformed with a distance threshold condition, determining whether a distance change between the at least one external object and the electronic device is conformed with a distance change threshold condition, determining whether an acceleration of the at least one external object in relative to the electronic device is conformed with an acceleration threshold condition, and determining whether an acceleration change of the at least one external object in relative to the electronic device is conformed with an acceleration change threshold condition.

7. The control method of an electronic device as recited in claim 1, wherein the step of controlling the electronic device by using the first configuration information comprises:
showing a user interface on a screen of the electronic device, and showing at least one object on the user interface via a first mode, and
when the distance information is determined to be conformed with the threshold condition, the step of switching to control the electronic device by using the second configuration information comprises:
switching to show the at least one object on the user interface via a second mode.

8. The control method of an electronic device as recited in claim 7, wherein the step of switching to show the at least one object on the user interface via the second mode comprises at least one of the following steps:
switching an arrangement of the at least one object on the user interface, switching an amount of the at least one object shown on the user interface, switching from displaying first information of the at least one object to displaying second information of the at least one object, and switching from displaying a first object in the at least one object to displaying a second object in the at least one object.

9. The control method of an electronic device as recited in claim 7, wherein the step of switching to show the at least one object on the user interface via the second mode comprises:
showing at least one functional option, wherein each of the at least one functional option is related to one of the at least one object, and
the method further comprises:
receiving an operation corresponded to one of the at least one functional option; and
executing an application function corresponded to one of the at least one object according to the operation.

10. The control method of an electronic device as recited in claim 7, wherein the step of switching to show the at least one object on the user interface via the second mode comprises:
obtaining at least one target object in the at least one object that is conformed with a target condition; and
showing the at least one target object on the user interface via the second mode.

11. An electronic device comprising:
a sensor;
a storage circuit configured to store first configuration information and second configuration information; and
a processing circuit coupled to the sensor and the storage circuit, wherein the processing circuit is configured to execute the following operations:
controlling the electronic device by using the first configuration information;
determining whether at least one external object independent of the electronic device is existed in response to a trigger event through using the sensor;
obtaining distance information of the at least one external object through using the sensor when the at least one external object is determined to be existed;
determining whether the distance information is conformed with a threshold condition; and
switching to control the electronic device by using the second configuration information when the distance information is determined to be conformed with the threshold condition.

12. The electronic device as recited in claim 11, further comprising:
an input/output device coupled to the processing circuit,
wherein after the operation of controlling the electronic device by using the first configuration information, the processing circuit is further configured to execute the following operations:
determining whether an operation command is received by the electronic device through the input/output device within a preset time range; and
generating the trigger event if the electronic device does not receive the operation command within the preset time range.

13. The electronic device as recited in claim 11, further comprising:
a screen coupled to the processing circuit,
wherein the operation of the processing circuit in determining whether the at least one external object independent of the electronic device is existed through using the sensor comprises:
determining whether at least one object to be detected is existed in front of a screen of the electronic device by less than a preset distance apart through using the sensor; and
determining that the at least one external object independent of the electronic device is existed when the at least one object to be detected is determined to be existed in front of the screen by less than the preset distance apart, and setting the at least one object to be detected as the at least one external object.

14. The electronic device as recited in claim 11, wherein the distance information of the at least one external object comprises at least one of information of a distance between the at least one external object and the electronic device, information of an distance change between the at least one external object and the electronic device, information of an acceleration of the at least one external object in relative to the electronic device, and information of an acceleration change of the at least one external object in relative to the electronic device.

15. The electronic device as recited in claim 14, wherein when an amount of the at least one external object is greater than one, the distance between the at least one external object and the electronic device comprises an average value of distances between each of the external objects and the electronic device, the distance change between the at least one external object and the electronic device comprises an average value of the distance changes between each of the external objects and the electronic device, the acceleration of the at least one external object in relative to the electronic device comprises an average value of the accelerations of each of the external objects in relative to the electronic device, and the acceleration change of the at least one external object in relative to the electronic device comprises an average value of the acceleration changes of each of the external objects in relative to the electronic device.

16. The electronic device as recited in claim 11, wherein the operation of the processing circuit in determining whether the distance information is conformed with the threshold condition comprises at least one of the following operation:
determining whether a distance between the at least one external object and the electronic device is conformed with a distance threshold condition, determining whether a distance change between the at least one external object and the electronic device is conformed with a distance change threshold condition, determining whether an acceleration of the at least one external object in relative to the electronic device is conformed with an acceleration threshold condition, and determining whether an acceleration change of the at least one external object in relative to the electronic device is conformed with an acceleration change threshold condition.

17. The electronic device as recited in claim 11, further comprising:
a screen coupled to the processing circuit,
wherein the operation of the processing circuit in controlling the electronic device by using the first configuration information comprises:
showing a user interface on the screen, and showing at least one object on the user interface via a first mode, and
when the distance information is determined to be conformed with the threshold condition, the operation of the processing circuit in switching to control the electronic device by using the second configuration information comprises:
switching to show the at least one object on the user interface via a second mode.

18. The electronic device as recited in claim 17, wherein the operation of the processing circuit in switching to show the at least one object on the user interface via the second mode comprises at least one of the following operations:
switching an arrangement of the at least one object on the user interface, switching an amount of the at least one object shown on the user interface, switching from displaying a first information of the at least one object to displaying a second information of the at least one object, and switching from displaying a first object in the at least one object to displaying a second object in the at least one object.

19. The electronic device as recited in claim 17, further comprising:
an input/output device coupled to the processing circuit,
wherein the operation of the processing circuit in switching to show the at least one object on the user interface via the second mode comprises:
showing at least one functional option, wherein each of the at least one functional option is related to one of the at least one object, and
the processing circuit is further configured to use the input/output device to receive an operation corresponded to one of the at least one functional option, and execute an application function corresponded to one of the at least one object according to the operation.

20. The electronic device as recited in claim 17, wherein the operation of the processing circuit in switching to show the at least one object on the user interface via the second mode comprises
obtaining at least one target object in the at least one object that is conformed with a target condition; and
showing the at least one target object on the user interface via the second mode.
